(19) United States
(12) Patent Application Publication
(10) Pub. No.: US 2014/0116793 A1
(43) Pub. Date: May 1, 2014

(54) HYBRID VEHICLE

(71) Applicants: Martin Pelletier, Levis (CA); Alain Dulac, St-Jean-Chrysostome (CA); Christophe Lemarechal, Levis (CA)

(72) Inventors: Martin Pelletier, Levis (CA); Alain Dulac, St-Jean-Chrysostome (CA); Christophe Lemarechal, Levis (CA)

(73) Assignee: PREVOST, UNE DIVISION DE GROUPE VOLVO CANADA INC., Sainte-Clare (CA)

(21) Appl. No.: 14/124,973

(22) PCT Filed: Jun. 5, 2012
(86) PCT No.: PCT/CA2012/050377

§ 371 Date: Dec. 9, 2013

Related U.S. Application Data
(60) Provisional application No. 61/495,057, filed on Jun. 9, 2011.

(51) Int. Cl. B60K 6/44; B60W 20/00

(52) U.S. Cl. CPC B60K 6/44; B60W 20/00; Y10S 903/916
USPC 180/65.225; 60/698; 903/916

(57) ABSTRACT

The hybrid vehicle can have a heat engine driving a first pair of wheels and an electric motor on another pair of wheels. The electric motor is selected to have a greater power than the heat engine, such as corresponding to the maximum power requirement of the vehicle, whereas the heat engine can have a power corresponding to a cruise power requirement of the vehicle. A generator is coupled to the heat engine and can be designed to have a generator capacity corresponding to the power of the heat engine. The electric motor can be used for propulsion during city driving conditions, and the heat engine can be used for propulsion during long range highway conditions, for instance. The design can be considered a power split through the road approach.

### BACKGROUND

Although hybrid vehicle concepts are becoming more and more widespread on automobiles, pickups and city buses, their use has been limited on vehicles such as heavier trucks, motor homes, passenger coaches, and the like. There thus remained room for improvement.

### SUMMARY

This specification describes an approach referred to herein as power split through the road, which can be applied to heavy vehicles and/or to vehicles adapted for doing a lot of highway driving compared to city driving. More precisely, the example described below can function in pure electric, pure series, parallel, or heat engine only modes as will be described.

A vehicle has different power requirements depending on the circumstances of its use.

For instance, when cruising at highway speeds on a flat surface, the power requirement, referred to herein as the “cruise power requirement”, can correspond to the amount of power required to counter frictional resistances such as bearing and transmission losses, tire rolling resistance, and aerodynamic drag, in addition to powering any auxiliary loads of the vehicle such as air conditioning, cooling fan or pump, air brake compressor, power steering, lights, etc. For heavy vehicles which are designed for use on long distances, the cruise power requirement corresponds to a main operating point—i.e. the vehicle functions in cruise more than in city driving conditions. In heavy vehicles, the tire rolling resistance can become significant, requiring more power, especially when operating the vehicle at gross vehicle weight—i.e. when the vehicle is fully loaded with cargo or passengers. Henceforth, the cruise power requirement can be defined for the worst-case scenario of operating the vehicle at gross vehicle weight and towing capacity. In vehicles which are not designed for towing, the towing capacity can be said to be nil.

However, even if likely to be most often used cruising at highway speeds on flat roads, the vehicle needs to be operable in other driving conditions, and vehicle operators typically request a sufficient acceleration capacity during stop and go traffic conditions, and a satisfactory capacity to go uphill at a satisfactory speed at gross vehicle weight. This power requirement, for a given vehicle, will be referred to herein as the “maximum power requirement” and is greater than the “cruise power requirement”.

From the above, it can be seen that many heavy vehicles have both a cruise power requirement which can represent a main operating point (i.e. a regime at which the vehicle is most often operated), and a higher maximum power requirement for special circumstances such as stop and go acceleration and uphill driving.

The typical approach to non-hybrid heavy vehicles is to provide the vehicle with a heat engine, e.g. an internal combustion engine such as a Diesel or gasoline engine, having a satisfactory maximum power given the predetermined maximum power requirement of the vehicle. This led to using internal combustion engines which were much larger than required to satisfy the cruise power requirement, and these engines were not used at their best efficiency at their main operating point.

The efficiency of the engine affects the amount of fuel consumed to produce a given amount of work. The more power is being produced for a given rate of fuel consumption, the more the engine can be said to be efficient, or fuel efficient. The fuel efficiency of a given engine varies not only depending on the RPM at which it is operated, but further depending of the power (proportional to torque) at which it is operated for a given RPM (i.e. depending on the rate of fuel intake for a given RPM, or how deep the gas pedal is pressed for instance). For a given engine, the efficiency can be plotted on a graph.

An example of a fuel efficiency graph is shown at FIG. 1. From this graph it can be seen for instance that engine efficiency falls rapidly in the lower values of torque. The point of maximum fuel efficiency A is located in a relatively small region of best efficiency on the graph, corresponding to operating the engine within a limited range of torque or power, within a limited range of RPM. For this particular engine, the efficiency rises above 195 g/kWh in this region of the graph, meaning that it takes less than 195 grams of fuel to produce 1 kWh of work. Looking at this graph with uttermost precision, one can identify a rather precise value of RPM and torque/power for which the engine would function at its theoretical point of maximum fuel efficiency. In practice the value can be reached within certain tolerances. The limits set by these tolerances can define the limits of a region referred to as a zone of maximum efficiency, for instance.

Let us now give an example to explain how the heat engine was selected in a former non-hybrid diesel engine passenger coach. In this case, the maximum power requirement was determined. It could be in the order of 400 HP for instance. Then, an appropriate heat engine was selected to fit this maximum power requirement, such as a heavy-duty Diesel engine for instance. This gave the operator sufficient power in the minority driving conditions where strong acceleration capacity was desired or uphill driving was required. However, in the typical mode of operation where cruising at highway speeds on a flat surface and minor wind effects, the engine was only operated at power values ranging between about 150 and 180 HP, mainly depending on whether the air conditioning was powered on or not. This can be referred to as a cruise power requirement. With a typical transmission gearing, this cruise operating point B was quite far from the point A of highest efficiency of the engine.

An approach describes herein and which will be detailed below is to rather select the power of the heat engine based on the cruise power requirement rather than the maximum power requirement, and to use an electric motor to provide the additional power. In this manner, the heat engine can be operated continuously at a point of maximum efficiency A rather than at varying operating conditions which were often far off the region of highest efficiency.

In accordance with one aspect, there is provided a hybrid vehicle having a cruise power requirement and a maximum power requirement, comprising: a wheeled frame having at least two pairs of wheels including a first pair of wheels and a second pair of wheels; a heat engine having a heat engine power corresponding to the cruise power requirement of the vehicle; a first electric machine coupled to the heat engine, and having a generator capacity corresponding to the heat engine power; a second electric machine having an electric motor power being at least equal to the heat engine power, the second electric machine being drivingly coupled to the second pair of wheels; and a battery connected to both the first electric machine and the second electric machine.

In accordance with another aspect, there is provided a method of operating a hybrid vehicle having a heat engine power and being drivingly coupled to a first pair of wheels of the vehicle; a first electric machine coupled to the heat engine, and having a generator capacity; a second electric machine having an electric motor power higher than the heat engine power, the second electric machine being drivingly coupled to a second pair of wheels of the vehicle; and a battery connected to both the first electric machine and the second electric machine, and further comprising a control system, the method comprising: operating the control system in a first mode upon determining highway driving conditions, in which the first electric machine is controlled in a manner allowing the heat engine to drive the wheels; and operating the control system in a second mode in which the second electric machine is controlled to drive the wheels while the heat engine does not drive the wheels.

In accordance with another aspect, there is provided a method of designing a hybrid vehicle propulsion system for a vehicle, the method comprising: establishing a cruise power requirement of the vehicle; establishing a maximum power requirement of the vehicle; identifying a heat engine corresponding to the cruise power requirement and being drivingly coupleable to a first pair of wheels of the vehicle; identifying a first electric machine coupleable to the heat engine, and having a generator capacity corresponding to the cruise power requirement; identifying a second electric machine corresponding to the maximum power requirement of the vehicle and being drivingly coupleable to a second pair of wheels of the vehicle.

In accordance with another aspect, there is provided a hybrid propulsion system for a vehicle, the propulsion system comprising: a heat engine having a heat engine power and being drivingly coupled to a first pair of wheels of the vehicle; a first electric machine coupled to the heat engine, and having a generator capacity; a second electric machine having an electric motor power higher than the heat engine power, the second electric machine being drivingly coupled to a second pair of wheels of the vehicle; and a battery connected to both the first electric machine and the second electric machine.

It will be noted here that the expression power refers to an amount of work (energy) delivered per unit time. Power and torque are related by the equation: power=torque*constant*RPM, where the constant depends on the units used, so knowing either torque or power at a given RPM, one can directly calculate the other. Fuel can be seen as energy chemically stored in a given amount of a substance, similarly as to how electrical energy can be stored in a battery.

### DESCRIPTION OF THE FIGURES

FIG. 1 is a graph showing a typical fuel efficiency distribution of a heat engine depending on torque and RPM;

FIG. 2 schematically illustrates a first example of a hybrid vehicle;

FIG. 3 is a graph showing a typical efficiency of an electric machine depending on torque and RPM;

FIGS. 4A, 4B and 4C show alternatives to the example of FIG. 2;

FIGS. 5A to 5H show corresponding modes in which the hybrid vehicle of FIG. 2 can be operated; and

FIG. 6 shows conditions under which the modes shown in FIGS. 5A to 5H can be used.

### DETAILED DESCRIPTION

An example of the new hybrid approach taught herein is shown in FIG. 2, on a vehicle 10 having a chassis with at least two pairs of wheels referred to herein as the first pair of wheels 12 and the second pair of wheels 14. In this example, the first pair of wheels 12 and the second pair of wheels 14 are mounted on corresponding axles, referred to here correspondingly as a first axle 16 and a second axle 18. Essentially, it can be understood that this example uses a heat engine 20 coupled to drive one of the sets of wheels 12, via a mechanical transmission 21. A first electric machine 22, referred to herein as the generator 22a, is coupled to the heat engine 20. A second electric machine 24, referred to herein as the electric motor 24a, is coupled to drive another one of the sets of wheels 14, optionally via a transmission 26.

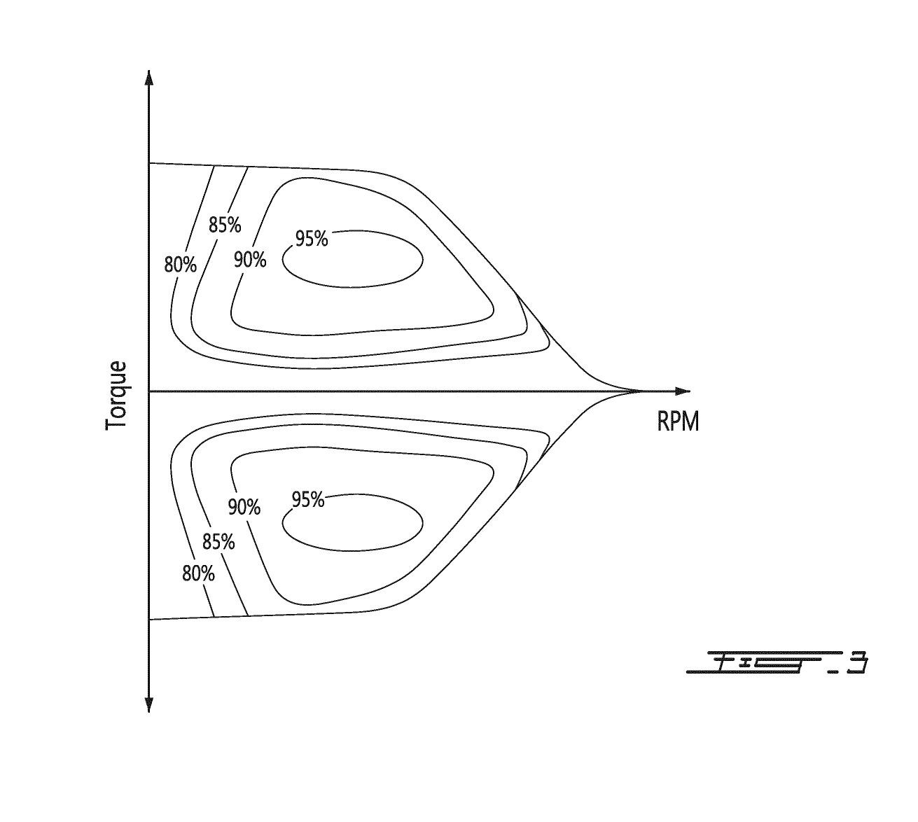

Although illustrated as a bloc, it will be understood that either one of the first electric machine 22 and the second electric machine 24 can actually include either a single unit having the total electric machine power, or a plurality of units which collectively sum up to the total power of the respective electric machine—an example of which is presented in FIG. 4A showing two electric machines coupled to the second pair of wheels 14 via a single transmission. Further, as will be understood from this description, both the electric motor 24a and the generator 22a can be capable of functioning in either one of motor mode or generator mode in this example. Further, for the sake of convenience, in this text, the pair of wheels driven by the heat engine 20 will be referred to as the first pair of wheels 12 and the one driven by the electric motor 24a will be referred to as the second pair of wheels 14. For the sake of convenience, the expressions first and second are used herein irrespective of the position of the given pair of wheels on the vehicle and of whether the wheels have simple or double tires for instance.

The pairs of wheels 12, 14 are already linked to one another through the road, so interconnecting them mechanically is optional and can be omitted. Nonetheless, a mechanical interconnection can be used in embodiments where it is desired to spread the traction of any one of the propulsion systems onto a greater number of wheels, for instance.

Also noted here, it can be seen that the heat engine 20 is coupled to its axle via a transmission 21, and that the generator 22a is coupled between the heat engine 20 and the transmission 21 in this specific case. Both the generator 22a and the electric motor 24a are connected to a battery 28.

According to this exemplary approach, the heat engine 20 can be significantly downsized and selected to satisfy the cruise power requirement rather than the maximum power requirement.

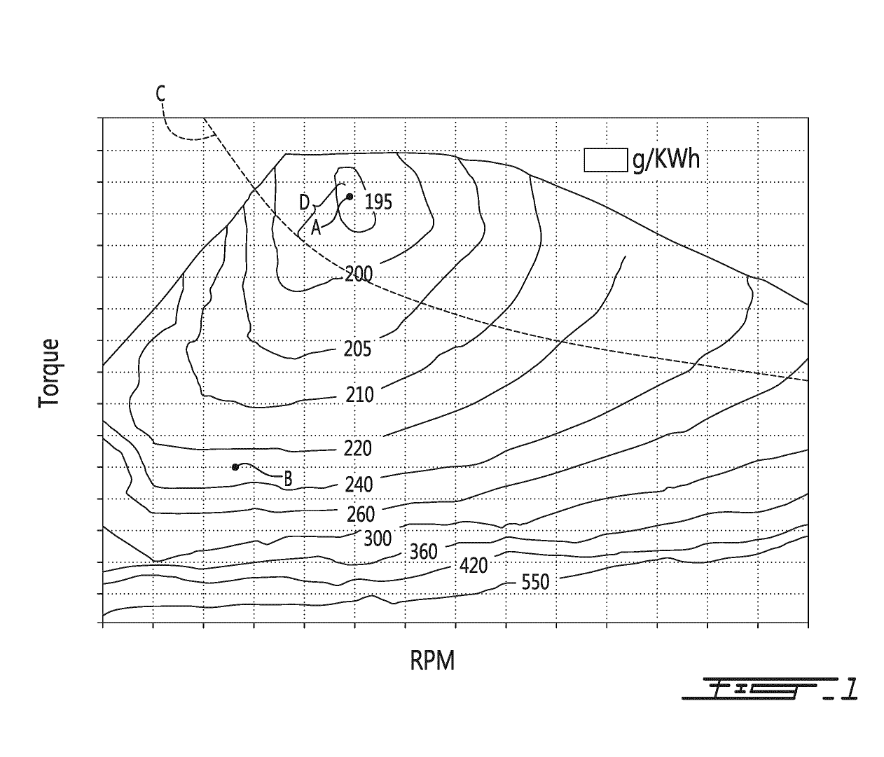

In an example embodiment adapted to the characteristics of a coach, for instance, the heat engine 20 can be a 215 HP engine, which is likely to have a fuel efficiency graph also similar to the generic one shown in FIG. 1, but for which the cruise power operating point matches (as close as practical if selecting from a finite selection of existing engines) the point of maximum fuel efficiency A, rather than the former cruise power operating point B. The engine so selected would thus be operable at a significantly better efficiency in the recurring cruise driving conditions. When the actual cruise conditions vary, the generator 22a can be used to transfer a corresponding varying amount of power D to (or from) the battery 28 while the heat engine 20 can continuously be operated at or at least closer to its highest efficiency operating point A.

When the expression “heat engine power corresponding to the cruise power requirement” is used herein, it will be understood that in practice, the heat engine 20 can be selected to have an amount of power at its point of maximum efficiency A which is actually slightly higher than a theoretical cruise power requirement C (which can nonetheless be determined at full auxiliary loads and taking into account potential effects of minor slope or minor wind) by a buffer amount of power D which will typically be minor when compared to the overall power of the heat engine 20. Selecting a buffer amount of power D can provide a form of safety margin by which extra assurance that the battery can be satisfactorily charged is obtained at the expense of a slight potential waste of electrical energy or of operating the heat engine slightly outside its point of maximum efficiency A. In other words, heat engine power can correspond to the cruise power requirement taking into account a buffer amount of power D.

Henceforth, it is now understood that heat engines can be a lot more efficient when operated at or near the operating point A as suggested above, than when formerly operated in stop and go driving conditions where their point of operation travelled along the graph in zones of lesser efficiency and where gearing often needed to be changed. It will be noted here that the variations of acceleration, or torque interruption such as can result from changing gear, can represent sources of discomfort to some passengers and is an undesired side-effect of the way former systems were operated.

It will also be understood that the example approach schematized in FIG. 2 allows operating the heat engine 20 in series mode in situations other than the cruise scenario, where the heat engine 20 would otherwise be used with a lesser efficiency. In this example, the generator 22a can be selected in a manner to be capable of absorbing the entire power emitted by the heat engine 20, while the heat engine 20 is in fact disengaged from the wheels. The generator 22a can thus transfer the heat engine power to the battery 28 to recharge it while the heat engine 20 can be operated continuously at or near its point of maximum efficiency A. A 200 HP electric generator was selected to this end in this example.

The second electric motor 24a can be used to power the second pair of wheels 14 of the vehicle 10 in stop and go city driving conditions, using electric energy stored in the battery. Electric motors can handle discontinuous or varying operating conditions much more efficiently than heat engines, and can provide the benefit of (quasi) full torque at zero RPM. Further, some electric motors can be selected for which a significantly reduced amount of gearing is required, which can accordingly provide better comfort to passengers. Alternately, an other source of power can be used to compensate for drops of acceleration during gearing of the main source of power for a given mode.

In this specific example, the electric motor 24a was selected to entirely satisfy the maximum power requirement of the vehicle 10, which allows the vehicle operator to make no compromise in performance when the vehicle 10 is functioning in pure series mode (i.e. if the heat engine is used solely to charge the battery in city driving conditions for instance). A 420 HP electric motor was selected to this end in this example. In alternate embodiments, a smaller electric motor can be used to compromise on maximum power while potentially extending range or reducing fuel consumption, for instance. It will be noted that in this example, the power of the electric motor is not only higher than the power of the heat engine, but significantly higher, e.g. roughly twice as powerful. Given the range of speeds (wheel or axle revolution rates) over which the use of the electric motor 24a was envisaged in this embodiment, an optional transmission 26 consisting of a 2-speed gearbox was used. Of course, if used, the gearbox can have more than 2 speeds.

It will be noted here that the expression electric motor 24a is used generically herein for the sake of simplicity and clarity. It will be understood that the electric motor 24a, or second electric machine 24, can include more than one unit mounted on corresponding wheels for instance instead of being a single device connected to an axle optionally via a transmission. An example of such a configuration is shown in FIG. 4A. Similarly, the expression battery is used generically and is intended to include the expression battery pack and thus include more than one actual battery device or pack, for instance.

Another benefit from using a high power electric motor is that its high power can also be used during regenerative braking to produce high power regenerative braking, which can be harnessed to convert a higher amount of braking power to electricity and thus more fully recharge the battery 28.

Also, in an envisaged mode of operation, the generator 22a can provide additional brake regeneration on the other axle allowing even more efficient energy recuperation.

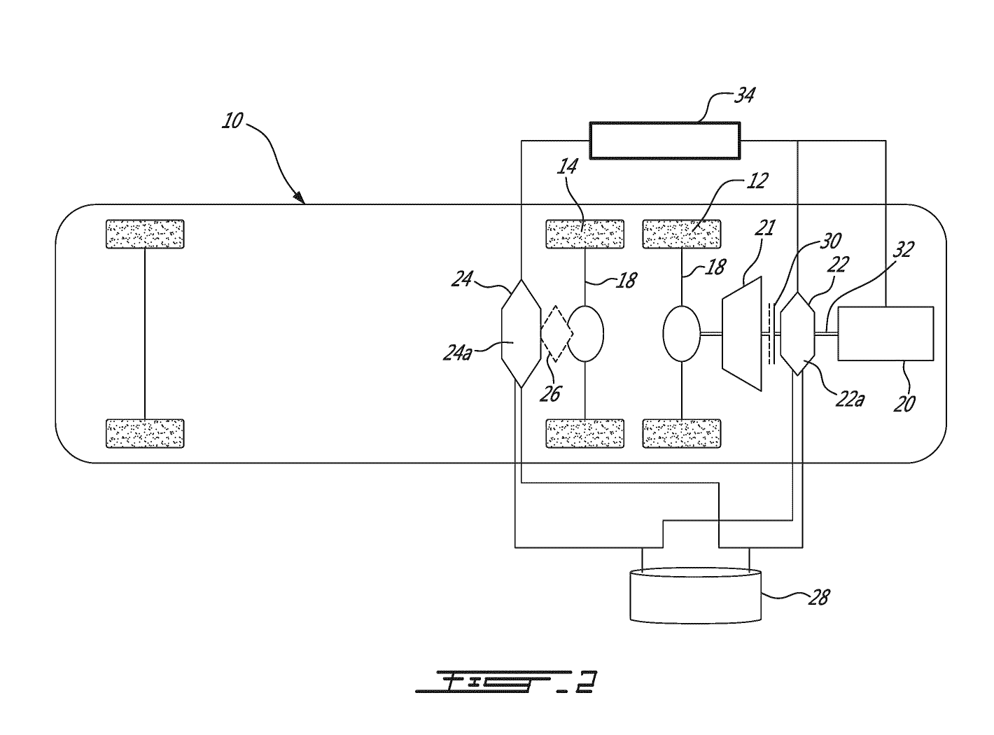

FIG. 3 shows an example of an efficiency graph for an electric machine. Of course, since electric machines are often operable both to produce power and inversely to regenerate the battery, the graph extends into both positive and negative values of power. The efficiency is based on the amount of electricity which is converted into power, or vice versa for regenerative braking.

The internal combustion engine, or heat engine 20, being relieved from the discontinuity of stop and go city driving, it can thus be continuingly operated at or near its most efficient operating point A while the electric motor 24a does the hard discontinuous acceleration work for which it can be more efficient than the heat engine 20, while the power of the heat engine 20 can be converted to electricity by the generator 22a and stored in the battery 28 in a series mode. A generator 22a having a peak energy conversion efficiency near the most efficient operating point A of the heat engine 20, in terms of power, can be selected to achieve a good match. If the level of charge of the battery 28 reaches a satisfactory level of charge, the heat engine 20 can be simply shut down to avoid wasting fuel. Alternately, it can be kept idle.

When cruising at highway conditions, range is a requirement. Given the current state of technology, range can be better achieved when using fossil fuel as the energy source. Henceforth, during highway driving, the heat engine 20 can be drivingly engaged to the first pair of wheels 12, or first axle. In this example, this is done via a transmission 21. More particularly, in this particular example, the generator 22a can be connected to the transmission 21 via a clutch 30, whereas an interface between the heat engine 20 and the generator 22a can be with or without a clutch. Examples of alternate embodiments to the heat engine 20, transmission 21 and generator 22a configuration of FIG. 2 are shown in FIGS. 4B and 4C.

When less than the operating power at the most efficient operating point A is required to propel the vehicle 10 (which would likely occur at least when the vehicle is going downhill, or receiving rear wind for instance, or when the air conditioning is turned off), the engine 20 can continue to be operated at its most efficient operating point A and the extra power can be diverted from the transmission by the generator, to recharge the battery, or turned off altogether.

The vehicle 10 can function as a parallel hybrid. A parallel hybrid mode can be used where power is prioritized, where the electric motor 24a can be independently used to add to the heat engine power and reach an impressive amount of power to pass other vehicles or to go uphill for instance. This can be particularly useful in motor home applications, for instance, especially where performance is a requirement or a trailer is used.

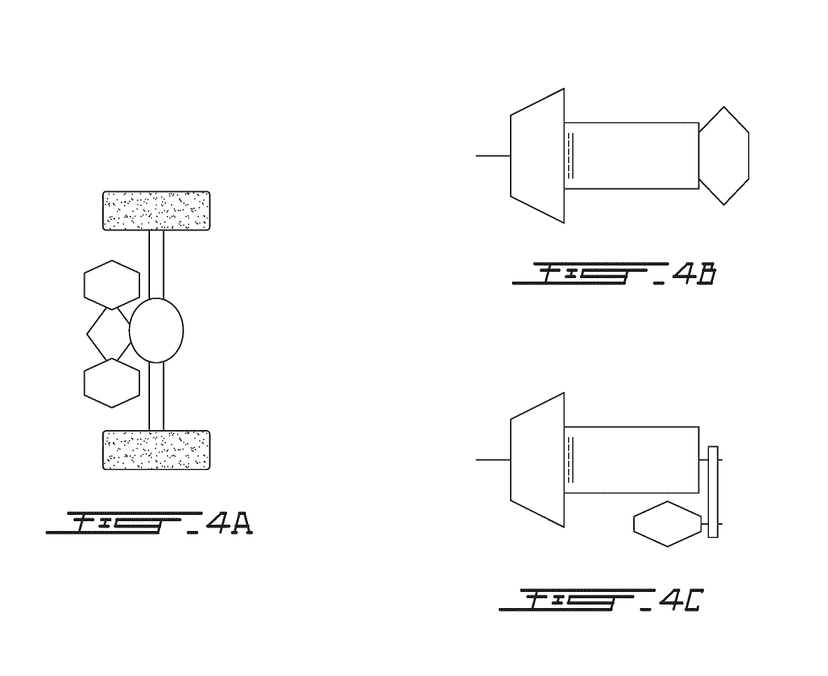

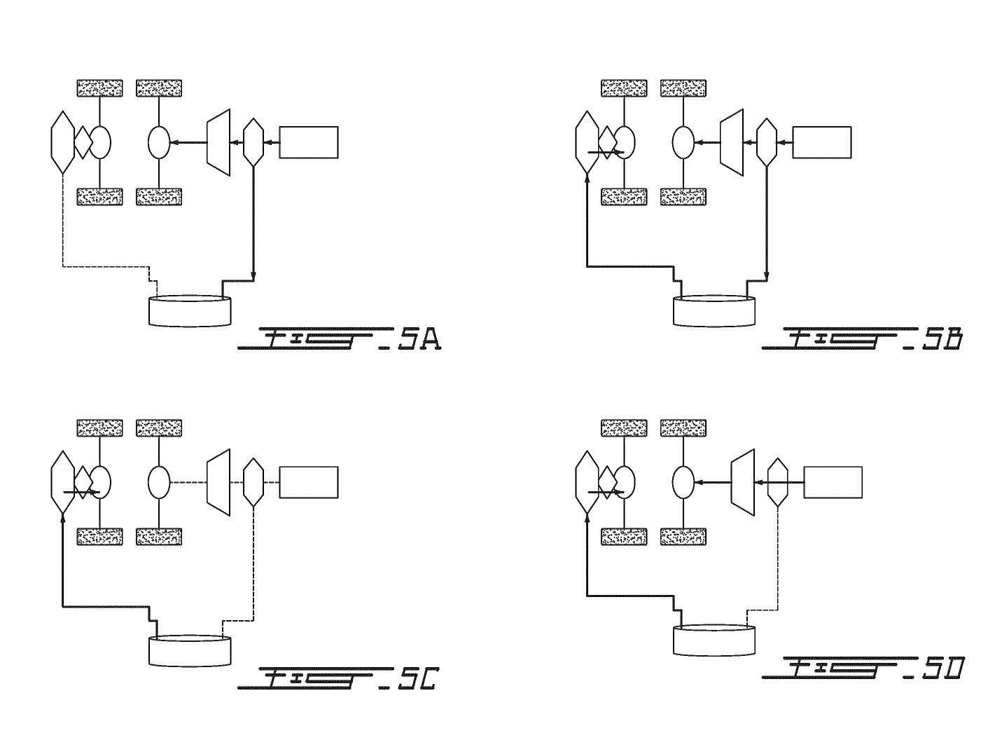

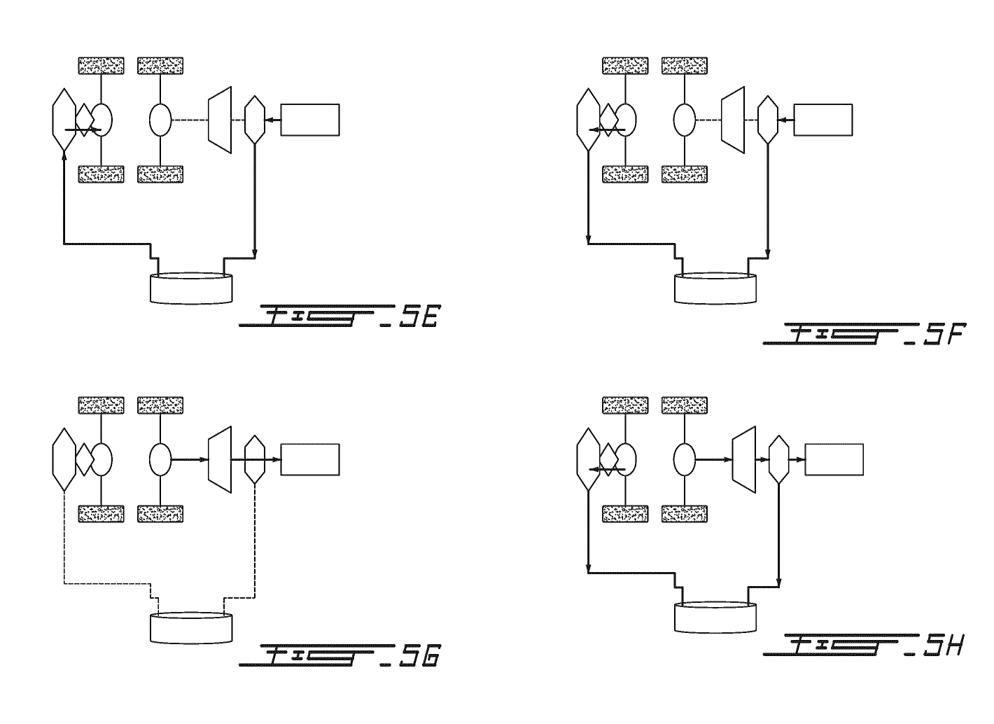

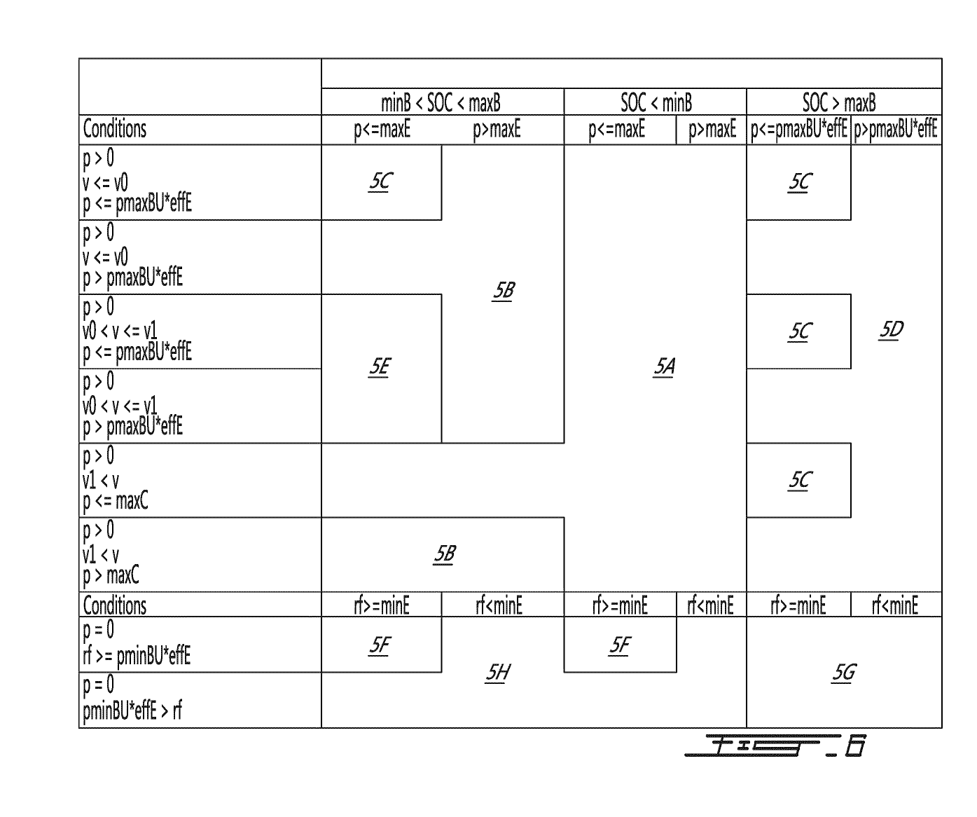

FIG. 5A to 5H show several modes by which the exemplary arrangement taught in FIG. 2 can be operated, whereas FIG. 6 shows conditions under which each mode can be used.

More particularly, FIG. 5A shows a thermal mode where the heat engine functions close to its point of highest fuel efficiency A to drive the wheels. Any excess power can be diverted to the battery via the generator.

FIG. 5B shows a first parallel mode where the electric motor is used to supplement power from the heat engine in driving the wheels, the heat engine being at its point of highest fuel efficiency or full engine power for instance.

FIG. 5C shows a pure electric mode where only the electric motor is used to power the wheels, the heat engine can be idling, or stopped.

FIG. 5D shows a second parallel mode, where the electric motor is at its point of highest efficiency or full power, and the heat engine is used to supplement the power of the electric motor. In such a case, the heat engine can be functioning at its point of highest fuel efficiency, for instance, and excess power be diverted to the battery by the generator.

FIG. 5E shows a series mode where the heat engine can be operated at its point of highest efficiency and the generator transfers its entire power to the battery, the vehicle being entirely driven by the electric motor which drains its power from the battery.

FIG. 5F shows a maximized charging mode where the electric motor is used in generator mode to brake the vehicle and charge the battery using braking power, while the heat engine continues to operate at its point of highest efficiency and the generator is simultaneously used to charge the battery.

FIG. 5G shows a retarder mode where engine braking is used and no charging occurs.

FIG. 5H shows a maximum braking mode where both the electrical motor and the generator are used to brake the vehicle and divert braking power to the battery, and the heat engine is also used in braking mode to brake the vehicle.

FIG. 6 shows conditions under which each mode can be used, where p is the required power, v is the speed, pmaxBU is the maximum instantaneous power that can be taken from the battery, effE is the instantaneous efficiency of the electrical motor, maxC is the maximum instantaneous power that can be taken from the heat engine, rf is the required braking power, pminBU is the max power that can be sent to the battery, SOC is the battery state of charge, minB is the minimum acceptable SOC, maxB is the maximum acceptable SOC, maxE is the max instantaneous power that can be taken from the electrical motor, minE is the max instantaneous power that can be generated with the electrical motor where v0 was selected as 10 km/h and v1 was selected as 90 km/h in this example.

A control system 34, schematically shown in FIG. 2, can receive information concerning the current conditions from associated sources, determine which mode is adapted to the specific condition, and then operate the heat engine, generator, and/or electric motor accordingly. This can be automated or partially automated using the controller, or can be manually controlled by a user, for instance. Alternately, to further enhance the efficiency of the system, this control can be based on pre-established conditions or determined using an intelligent GPS incorporating in advance the slope of the road and known road conditions, for instance.

In a simulation for a passenger coach, the exemplary arrangement taught in FIG. 2 and referred to herein as Power Split Through The Road, achieved better design results than with other hybrid concepts. The simulation was based on a 5 L heat engine, using a 12 speed automated manual transmission, a 140/200 kW (nominal/maximum) direct drive generator/drive.

The examples described above and illustrated are intended to be exemplary only. The scope is indicated by the appended claims.

1. A hybrid vehicle having a cruise power requirement and a maximum power requirement, comprising:
a wheeled frame having at least two pairs of wheels including a first pair of wheels and a second pair of wheels;
a heat engine having a heat engine power corresponding to the cruise power requirement of the vehicle, the heat engine being drivingly coupled to the first pair of wheels;
a first electric machine coupled to the heat engine, and having a generator capacity corresponding to the heat engine power;
a second electric machine having an electric motor power being at least equal to the heat engine power, the second electric machine being drivingly coupled to the second pair of wheels; and
a battery connected to both the first electric machine and the second electric machine.

2. The vehicle of claim 1 wherein the cruise power requirement includes an amount of power required to maintain highway speeds against frictional resistance, tire rolling resistance, and aerodynamic drag at gross vehicle weight and towing capacity and further to power auxiliary loads of the vehicle.

3. The vehicle of claim 1 wherein the electric motor power corresponds to at least the maximum power requirement of the vehicle.

4. The vehicle of claim 3 wherein the maximum power requirement corresponds to satisfactory acceleration capacity and gradability against frictional resistance, tire rolling resistance and aerodynamic drag, at gross vehicle weight and towing capacity.

5. The vehicle of claim 1 wherein the maximum power requirement is significantly higher than the cruise power requirement.

6. The vehicle of claim 1 wherein the electric motor power is higher than the heat engine power.

7. The vehicle of claim 6 wherein the electrical motor power corresponds to at least 1.5 times the heat engine power, and preferably to at least 2 times the heat engine power.

8. The vehicle of claim 1 wherein the heat engine has a zone of maximum fuel efficiency corresponding to the heat engine power at a given RPM.

9. The vehicle of claim 1 further comprising a transmission, wherein the heat engine is drivingly coupled to the first pair of wheels via the transmission.

10. The vehicle of claim 9 wherein the heat engine is drivingly coupled to the transmission via the first electric machine.

11. The vehicle of claim 1, further comprising a control system which can operate in a first mode upon determining highway driving conditions, in which the first electric machine is controlled in a manner allowing the heat engine to drive the wheels, and further can operate in a second mode in which the second electric machine is controlled to drive the wheels while the heat engine does not drive the wheels.

12. The vehicle of claim 11 wherein in the first mode, the second electric machine does not drive the wheels.

13. The vehicle of claim 11 wherein in the first mode the heat engine is operated in a zone of maximum efficiency, and the first electric machine is operated to transfer excess power from the heat engine to the battery.

14. The vehicle of claim 11 wherein upon determining an additional power requirement, the controller operates in the first mode with the heat engine operated in a zone of maximum efficiency and further transfers additional power from the battery to the second electric machine to drive the wheels.

15. The vehicle of claim 11 wherein the control system operates in the second mode upon determining that a level of charge of the battery has reached a given level, in which case the heat engine is one of deactivated and idling.

16. The vehicle of claim 11 wherein the control system operates in the second mode upon determining city driving conditions.

17. The vehicle of claim 16 wherein in the second mode, upon determining that a level of charge of the battery is below a certain level, the control system operates the heat engine in a zone of maximum efficiency and operates the first electric machine to fully transfer its power to the battery.

18. The vehicle of claim 9 wherein the transmission is coupled to an axle of the first pair of wheels, and the second electric machine is coupled to an axle of the second pair of wheels.

19. The vehicle of claim 1 wherein the second electric machine is coupled to the second pair of wheels via one of a gearbox and a transmission.

20. The vehicle of claim 19 wherein the one of a gearbox and a transmission is a gearbox having at least two speeds.

21. A method of operating a hybrid vehicle having a heat engine having a heat engine power and being drivingly coupled to a first pair of wheels of the vehicle; a first electric machine coupled to the heat engine, and having a generator capacity; a second electric machine having an electric motor power higher than the heat engine power, the second electric machine being drivingly coupled to a second pair of wheels of the vehicle; and a battery connected to both the first electric machine and the second electric machine, and further comprising a control system, the method comprising:
operating the control system in a first mode upon determining highway driving conditions, in which the first electric machine is controlled in a manner allowing the heat engine to drive the wheels; and
operating the control system in a second mode in which the second electric machine is controlled to drive the wheels while the heat engine does not mechanically drive the wheels.

22. The method of claim 21 wherein in the first mode, the second electric machine does not drive the wheels.

23. The method of claim 21 wherein said operating in the first mode includes operating the heat engine in a zone of maximum efficiency, and operating the first electric machine to transfer excess power from the heat engine to the battery.

24. The method of claim 21 wherein said operating in the first mode is done upon determining an additional power requirement, and further includes operating the heat engine in a zone of maximum efficiency and transferring additional power from the battery to the second electric machine to drive the wheels.

25. The method of claim 21 wherein said operating in the second mode is done upon determining that a level of charge of the battery has reached a given level, in which case the heat engine is one of deactivated and idling.

26. The method of claim 21 wherein the control system operates in the second mode upon determining city driving conditions.

27-30. (canceled)

31. A hybrid propulsion system for a vehicle, the propulsion system comprising:
a heat engine having a heat engine power and being drivingly coupled to a first pair of wheels of the vehicle;
a first electric machine coupled to the heat engine, and having a generator capacity;
a second electric machine having an electric motor power higher than the heat engine power, the second electric machine being drivingly coupled to a second pair of wheels of the vehicle; and
a battery connected to both the first electric machine and the second electric machine.

32. The hybrid propulsion system of claim 31 wherein the generator capacity corresponds to the heat engine power.

33. The hybrid propulsion system of claim 31 wherein the heat engine has a given zone of maximum fuel efficiency corresponding to a given operating power at a given RPM.

34. The hybrid propulsion system of claim 32 wherein the given operating power corresponds to a cruise power requirement of the vehicle.

35. The hybrid propulsion system of claim 33 wherein the electric motor power corresponds to a maximum power requirement of the vehicle.

36. The hybrid propulsion system of claim 31 wherein the electric motor power is more than 1.5 times the heat engine power.

37. The hybrid propulsion system of claim 31 wherein the battery is connected to receive power from and provide power to both the first electric machine and the second electric machine, both electric machines being operable to provide or receive power from the battery.

38. The hybrid propulsion system of claim 31 wherein the heat engine is coupled to the first pair of wheels of the vehicle via a transmission.

39. The hybrid propulsion system of claim 31 wherein the heat engine is an internal combustion engine, preferably a Diesel engine.
